(19) United States
(12) Patent Application Publication
(10) Pub. No.: US 2011/0168539 A1
(43) Pub. Date: Jul. 14, 2011

(54) DISTILLING MACHING ABLE TO PRODUCE DISTILLED WATER WITH MINERAL SUBSTANCES

(76) Inventor: Feng-Kuei CHEN, Tainan City (TW)

(21) Appl. No.: 12/686,395

(22) Filed: Jan. 13, 2010

(51) Int. Cl. B01D 3/38; B01D 3/02

(52) U.S. Cl. 202/185.3

(57) ABSTRACT

A distilling machine able to produce distilled water with mineral substance includes a cover body provided inside with a condensation tube filled therein with ore grains composed of various kinds of ores ground into powder, mixed and compressed into particles. Thus, when unboiled water is poured into a heating device of the distilling machine to be heated to boil and form steam, the steam will flow through the condensation tube to be combined with the mineral substance of the ore grains therein. Simultaneously, external cold air will be sucked by a fan in the cover body to flow into the cover body to lower the temperature of the steam and condense the steam into water drops, and then the water drops containing mineral substance will be collected in a water-reserving bucket.

### BACKGROUND OF THE INVENTION

1. Field of the Invention

This invention relates to a distilling machine, particularly to one able to produce drinkable pure and clean distilled water with mineral substances, which is beneficial to a man's health.

2. Description of the Prior Art

Generally, after water is boiled to form water vapor by a distilling machine, the water vapor will be simultaneously condensed into distilled water. In a boiling process in a distilling machine, impurities in unboiled water are completely removed so there is not any soluble mineral substance therein, and this tallies with what is defined about distilled water by the US Bureau of Environment. However, in reality, all the creation of the universe, inclusive of human bodies, is composed of chemical elements, and the nutrient matters that people need every day, such as carbohydrate, fat, protein, water, vitamins and mineral substances, are indispensable to human lives and activities. Among the nutrient matters, mineral substances and micro-elements, which are so-called “essential mineral substance” and “essential micro-element”, exist in natural water. Once the impurities in natural water are removed, the mineral substances beneficial to human bodies will disappear and, if deficient in either the essential mineral substances or the essential micro-elements, a man's body will be in an unhealthy condition and may give rise to metabolic disease, cancer, aging or chronic disease and even get ill by fat and overwork. Substantially, maintaining the density of mineral substances and micro-elements in a certain proportion is the basic necessities of a man's life and activity and is also the factor in keeping physiological functions normal and in preventing disease; therefore, simply drinking distilled water or pure water can hardly do much good to a man's health.

### SUMMARY OF THE INVENTION

The objective of this invention is to offer a distilling machine able to produce drinkable pure and clean distilled water with mineral substances, which are beneficial to a man's health.

The distilling machine in the present invention includes a heating device formed therein with an accommodating chamber having its lower side installed with a heater. A cover body is assembled on the topside of the heating device, having one sidewall bored with an air intake and its topside disposed with an air outlet. The cover body is further provided in the interior with a fan and a condensation tube bent into plural circles. The condensation tube has one end at the lower side of the cover body, provided with an air inlet and another end disposed with a water outlet and further has its outer side arranged with lots of cooling fins. A water-reserving bucket is positioned under the water outlet of the condensation tube.

The feature of the invention is that the condensation tube is filled therein with ore grains containing mineral substances, which are composed of various kinds of ores ground into powder, mixed and compressed into particles.

In addition, the air inlet and the water outlet of the condensation tube are respectively provided with a separating board bored with plural through holes.

### BRIEF DESCRIPTION OF DRAWINGS

This invention will be better understood by referring to the accompanying drawings, wherein:

FIG. 1 is a cross-sectional view of a distilling machine able to produce distilled water with mineral substance in the present invention;

FIG. 2 is partial magnified cross-sectional view of the distilling machine in the present invention; and

FIG. 3 is a cross-sectional view of the distilling machine in a using condition in the present invention.

### DETAILED DESCRIPTION OF THE PREFERRED EMBODIMENT

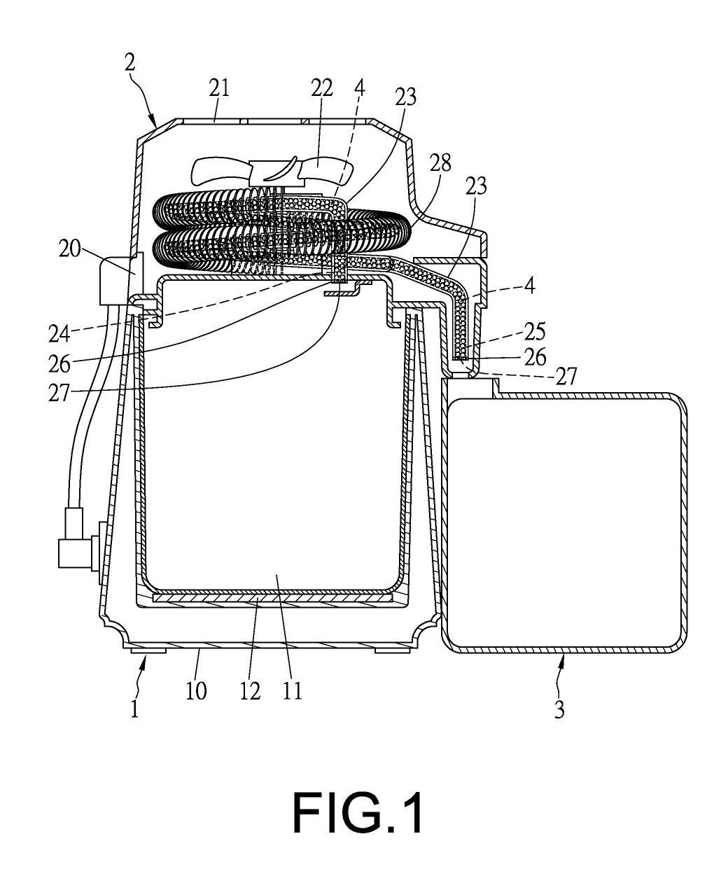

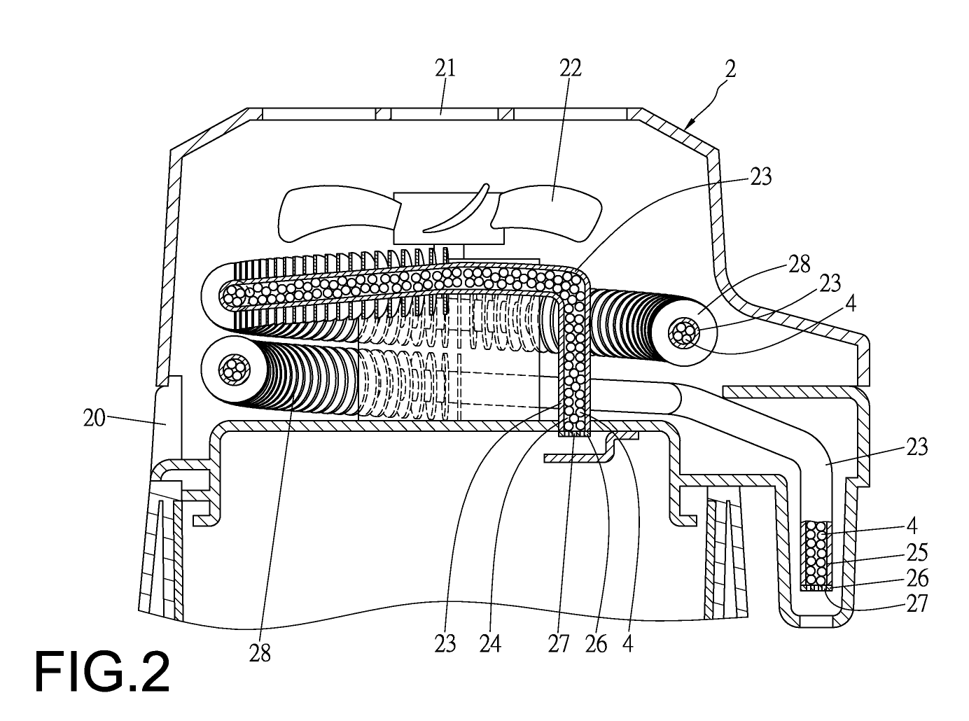

A preferred embodiment of a distilling machine able to produce distilled water with mineral substance in the present invention, as shown in FIG. 1 and 2, includes a distilling machine 1, a cover body 2 and a water-reserving bucket 3 combined together.

The distilling machine 1 is provided with a heating device 10 formed therein with an accommodating chamber 11 having its lower side installed with a heater 12.

The cover body 2 is assembled on the topside of the heating device 10, having one sidewall provided with an air intake 20 and its topside bored with an air outlet 21. The cover body 2 is further disposed in the interior with a fan 22 and a condensation tube 23 bent into plural circles and having one end at the bottom of the cover body 2 bored with an air inlet 24 and another end provided with a water outlet 25. The air inlet 24 and the water outlet 25 have their outer ends respectively set with a separating board 26 bored with several through holes 27, and the condensation tube 23 has its outer side arranged with lots of cooling fins 28.

The water-reserving bucket 3 is positioned under the water outlet 25 of the condensation tube 23. The condensation tube 23 is filled in the interior with ore grains 4, which contain mineral substances and are composed of various kinds of ores ground into powder, mixed and compressed into particles.

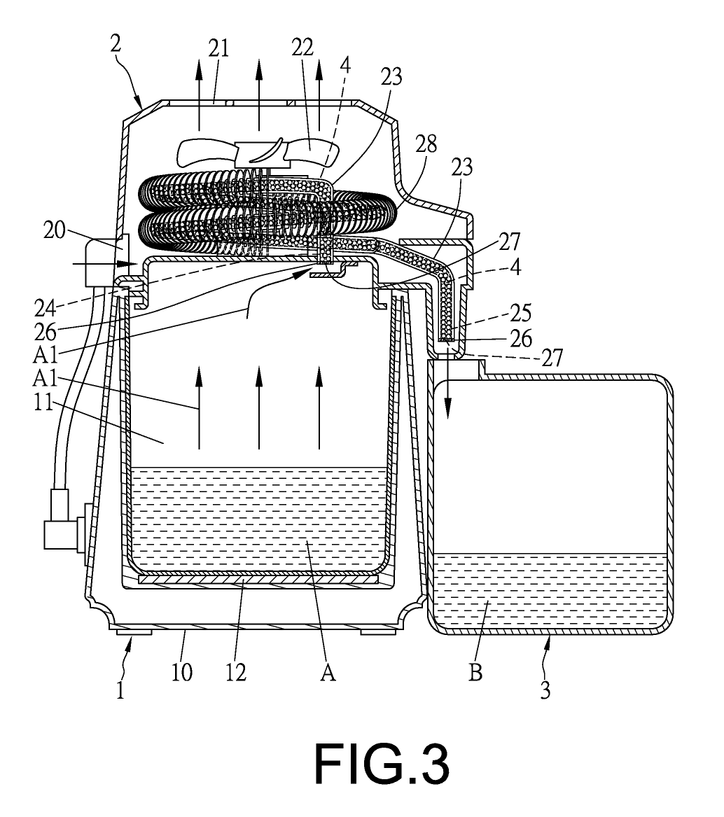

In using, referring to FIG. 3, after unboiled water (A) is poured into the accommodating chamber 11 of the heating device 10 and heated to boil and form steam A1 by the heater 12 at the lower side of the accommodating chamber 11, the steam A1 will rise to flow into the condensation tube 23 through the air inlet 24 of the condensation tube 23 in the cover body 2. When the steam A1 flows through the ore grains 4 in the condensation tube 23, the mineral substances of the ore grains 4 will be sucked into the steam A1 and in the meantime, external cold air will be sucked by the fan 22 to flow into the cover body 2 through the air intake 20 to lower the temperature of the steam Al in the condensation tube 23 and condense the steam A1 into water drops. Simultaneously, hot air in the cover body 2 will be blown out through the wind outlet 21 by the fan 22, and the water drops containing mineral substance will be guided into the water-reserving bucket 3 through the water outlet 25. Then, distilled water (B) produced by condensing the steam Al into water drops is collected in the water-reserving bucket 3, thus producing drinkable pure and clean distilled water (B) containing mineral substance and beneficial to a man's health.

While the preferred embodiment of the invention has been described above, it will be recognized and understood that various modifications may be made therein and the appended claims are intended to cover all such modifications that may fall within the spirit and scope of the invention.

What is claimed is:

1. A distilling machine able to produce distilled water with mineral substances, said distilling machine comprising a heating device, said heating device formed with an accommodating chamber in an interior, said accommodating chamber provided with a heater at a lower side, a cover body assembled on a topside of said heating device, said cover body having one sidewall bored with an air intake and a topside disposed with an air outlet, said cover body having a fan installed in an interior with a fan and a condensation tube bent into plural circles, said condensation tube having one end at a lower side of said cover body and provided with an air inlet and another end disposed with a water outlet, said condensation tube having an outer side arranged with lots of cooling fins, a water-reserving bucket positioned under said water outlet of said condensation tube; and,
characterized by ore grains with mineral substances filled in an interior of said condensation tube, said ore grains composed of various kinds of ores ground into powder, mixed and compressed into particles.

2. A distilling machine able to produce distilled water with mineral substance as claimed in claim 1, wherein said air inlet and said water outlet of said condensation tube are respectively provided thereon with a separator, said separating board bored with plural through holes.
